(19) United States
(12) Patent Application Publication
(10) Pub. No.: US 2012/0288629 A1
(43) Pub. Date: Nov. 15, 2012

(54) DEVICE AND METHOD FOR COATING IN THE EDGE AREA OF THE SMALL SIDES OF WORKPIECES

(75) Inventors: Daniel Ludewig, Bunde (DE); Wolfgang Fricke, Hiddenhausen (DE)

(73) Assignees: 3H-Lacke GmbH, Hiddenhausen (DE); LCM GmbH, Hiddenhausen (DE)

(21) Appl. No.: 13/469,784

(22) Filed: May 11, 2012

(30) Foreign Application Priority Data
May 13, 2011 (EP) 11003954.2

(51) Int. Cl. B05D 5/00; B05D 1/28; B05C 1/00

(52) U.S. Cl. 427/284; 118/255

(57) ABSTRACT

A device 1 for the application of coating agents in the edge area of the small sides of workpieces 8 comprises a conveyance device 2, a coating roller 3, and at least two coating stamps 4. The coating roller 3 and/or the coating stamps 4 is/are advanced to the workpiece 8 with the help of pneumatic cylinders 6. The coating roller 3 and the coating stamps 4 in each case include a spraying device 5. The spraying processes of the coating roller 3 and of the coating stamps 4 are in each case pneumatically controllable.

### TECHNICAL FIELD

The invention relates to a device and to a method for coating in the edge area of the small sides of workpieces. The invention further relates to a method for coating the edge area of the small sides of workpieces with treatment agents, particularly with coating agents.

### BACKGROUND INFORMATION

While the small sides of workpieces, such as, for example, wood plates, are often coated by machine using a throughput process method, in automated coating or painting, the edge areas are usually recessed, because, in the state of the art, the only available coating machines make it possible to coat and particularly to paint only flat surfaces, and not edges or corners. Accordingly, the edges and corners that have been recessed by processing by machine, have to be coated or painted by hand, wherein this work step occurs normally subsequently to the coating by machine of the surfaces.

The processing of the edges by hand has various disadvantages. First, manual labor is cost intensive. Moreover, using manual labor in industrial manufacture does not make it possible to achieve the regularity of an automated work method, which results in a slightly irregular coating or paint layer, and wherein, on the workpieces to be processed, drop formation or incipient drop formation can occur in particular.

The problem of the invention therefore is to make available a device and a method for coating in the edge area of the small sides of workpieces, which allow a regular coating, by machine, of the edge areas of workpieces and particularly of wood plates.

The problem is solved by a device for coating in the edge area of the small sides of workpieces according to the present invention, and by a method for coating the edge area of the small sides of workpieces with wood treatment agents and particularly with coating agents according to the method disclosed by the invention.

### SUMMARY

According to the present invention, a device is provided for the application of coating agents in the edge area of the small sides of workpieces, which comprises a conveyance device, a coating roller, and at least two coating stamps, wherein the coating roller and/or the coating stamps is/are advanced to the workpiece with the help of pneumatic cylinders, wherein the coating roller and the stamps in each case present a spraying device, and wherein the spraying processes of the coating roller and of the coating stamps in each case are pneumatically controllable.

The device provided according to the present invention for the application of coating agents in the edge area allows, for the first time, the coating by machine of edges and corners of a workpiece, such as, for example, the painting of a bottom edge with the transverse edges adjacent to it. Moreover, by means of the automated coating device, a regular application of a coating agent and particularly of paints is supported. Furthermore, when using the device according to the invention, personnel costs can be saved, because, instead of the manual application, only adjustments of the coating parameters on the control panel or in control software are required.

In an advantageous embodiment of the device according to claim 1, the coating device in addition presents a light barrier, wherein a double light barrier is preferably provided.

The light barrier allows a detection of the workpieces that are advanced to the coating device. The individual components of the coating device can be used in an event controlled manner after the interruption or release of the light barrier.

In an additional advantageous embodiment, the spraying devices and the pneumatic cylinders are triggerable at adjustable time intervals from the interruption of the light barrier, or after a renewed release of the light barrier.

After one of the workpieces has passed through the light barrier and interrupted the light beam of the light barrier, a signal is triggered by the light barrier. However, the workpiece reaches the various coating elements of the coating device at different times. Therefore, by means of an adjustability of the individual time delays, a coating that is adapted to the advance of the workpiece can occur, by means of the coating stamps or the coating roller which are at different distances from the light barrier.

It is advantageous that the spray processes occur at adjustable time intervals after the interruption or release of the light barrier, and last for in each case adjustable time intervals after the interruption or release of the light barriers.

For the more precise adjustment of the coating stamps or of the coating roller as well as of their spraying devices, not only the occupancy, i.e., the interruption of the light barrier, is evaluated; rather, it is also possible to use the release of the light barrier as triggering event, for example, to signal the end of a workpiece. In addition, for example, the operation of the coating roller can start after a defined time interval after the interruption of the light barrier, while it is stopped again after an additional adjustable time interval after the release of the light barrier. In this manner, the device according to the invention can react automatically to different lengths of the individual workpieces, without requiring any manual interventions, such as, for example, a changing of time parameters.

It is also advantageous that the pneumatic cylinders are deflectable in each case at adjustable time intervals after the interruption or release of the light barrier, wherein moreover the duration of the deflection of individual pneumatic cylinders is controllable by adjustable time intervals after the interruption or release of the light barrier.

By the adjustment of the time parameters for the pneumatic cylinders, the coating stamps or the coating roller can be advanced at the appropriate time to the workpieces brought close by the conveyance device.

In addition, it is advantageous that the spraying devices and/or the pneumatic cylinders are triggered respectively stopped or retracted, by the temporally controlled opening or closing of respective associated valves.

Valves are simple and cost effective devices, making it possible to trigger or again retract the pneumatic cylinders at the in each case adjustable time intervals. In particular, the pressurized air to be regulated can be delivered sufficiently promptly through valves to the pneumatic cylinders.

Furthermore, it is advantageous that a conveyor belt is provided as conveyance device.

A conveyor belt is a simple and efficient conveyance method for flat workpieces, wherein the workpieces can be applied, with a side that is not to be coated in the provided work step, to the conveyor belt. The edge areas of the small sides, which are to be coated, remain free, on the other hand.

In addition, it is advantageous that the device presents several coating stations, wherein the workpiece, after it leaves a coating station, and before it is supplied to a subsequent coating station, is rotated preferably by 90°, wherein, in the case of cuboid workpieces, up to four different coating positions are provided.

The use of several coating stations and repeated turning over of the workpieces makes it possible to completely coat by machine all the edge areas of the small sides. For example, a complete coating of all the edges can be appropriate if wood plates, as workpiece, are to be incorporated in open pieces of furniture, which are thus visible all around. In the case of closed high-quality pieces of furniture, a coating of all the edge areas can also be appropriate, so that the coated wood plates can be incorporated independently of a certain orientation, which is appropriate particularly for self installation and for moving.

It is also possible to provide that control software and/or a control panel is/are provided, for the adjustment of the time intervals.

By means of a control panel or control software, the time parameters can be set centrally, without the operating personnel having to adjust the individual valves, in case of changes in the adjustments.

Also disclosed is a method for coating the edge area of the small sides of workpieces with wood treatment agents and particularly with coating agents, which comprises the following steps: (A) transporting of a workpiece to be coated through a conveyance device during all the subsequent steps, (C) additional transport of the workpiece and, in the process, pressing of a coating roller against the longitudinal edge or bottom edge of the workpiece, with simultaneous spraying of the coating roller with coating agent by means of a spraying device, and, in the process, coating of the edge in the transport direction, wherein step C is maintained until step H is reached, (D) spraying of a coating stamp which is distal in the conveyance direction of the conveyance device, with coating agent from a spraying device, (E) additional transport of the workpiece, and coating of a front—in the conveyance direction—transverse edge by means of the distal coating stamp which is brought close to the workpiece for this purpose, (F) spraying of a proximal—in the conveyance direction of the conveyance device—coating stamp with coating agent from a spraying device, (G) additional transport of the workpiece and coating of a rear—in the conveyance direction—transverse edge by means of the proximal coating stamp brought close to the workpiece for this purpose, (H) additional transport of the workpiece and, in the process, removal of the coating roller from the workpiece.

The method according to the present invention allows an automated coating, such as, for example, a painting in the edge area of the small sides of workpieces, such as, wood plates. In the process, using the coating method according to the invention, a regular coating, such as, for example, an application of paints, is supported. Furthermore, when using the coating method, personnel costs are saved, because, instead of a manual application, only an adjustment of the parameters for the coating method needs to occur.

According to an advantageous embodiment of the method of the invention, the following is provided, as additional step: (B) transport of the workpiece to be coated through a light barrier and as a result interruption of the light beam, wherein it is preferred to provide a double light barrier.

By means of an additional light barrier, the workpieces that are brought close to the coating device are detected. The individual steps C to H of the coating process can subsequently be carried out with event-based control.

It is particularly advantageous that the events of steps C to H which are provided in addition to the transport alone of the workpiece are triggered at adjustable time intervals from the interruption of the light barrier, or after a renewed release of the light barrier.

Due to the evaluation of the two events detected by the light barrier, namely, interruption and release of the light barrier, the steps C to H can be adapted both to the rate of advance of the conveyance device and also to the length of the workpieces that are brought close in the conveyance direction.

Moreover, it is advantageous that the steps D and E occur at adjustable time intervals after the interruption of the light barrier, and last for in each case adjustable time intervals after the interruption of the light barrier.

By specifying the time intervals, it is possible to regulate not only the respective coating time, but also the coating duration of the individual coating steps.

It is also provided that the steps F and G occur at adjustable time intervals after the renewed release of the light barrier, and last for in each case adjustable time intervals after the renewed release of the light barrier.

Due to the evaluation of the two possible events of the light barrier, workpieces of different length can be processed, without requiring a new adjustment of the parameters. In particular, it is also possible to alternate using workpieces of different length on the conveyance device.

In addition, it is provided that the step C is triggered at an adjustable time interval after the interruption of the light barrier, and terminated after an additional adjustable time interval after the renewed release of the light barrier in step H.

For the complete coating of the longitudinal edges of the workpieces, the parameters have to be evaluated at the start and at the end of the workpiece to be coated. While the start of the workpiece can be detected by the interruption of the light beam of the light barrier, the light barrier is released again at the end of the respective workpiece. Step C therefore lasts until, due to the fact that the end of the workpiece has been reached, step H can occur, without any areas of the longitudinal edge remaining recessed.

It is also particularly advantageous that all the steps C to H are triggered or terminated pneumatically and/or hydraulically by the temporally controlled opening and closing of the respective associated valves.

By pneumatic or hydraulic operation of the coating roller or of the coating stamps, it is possible to control not only the spraying devices, but also the components which are to be advanced to the workpiece, by opening or closing valves.

In addition, it is advantageous that a conveyor belt is provided as conveyance device.

A conveyor belt is a simple and efficient method of conveying flat workpieces, wherein the workpieces are placed on the conveyor belt, with a side that is not to be coated in the provided work step. The edge areas of the small sides, which are to be coated, on the other hand, remain freely accessible to the individual process steps C to H.

Furthermore, it is possible to provide that the treatment of the workpiece in the steps A to H is repeated by rotating the workpiece by preferably 90°, wherein, in the case of cuboid workpieces, up to four different treatment positions are provided.

By turning the workpieces over, and subsequent repetition of the coating process, it is possible, for example, to completely coat all the edge areas of the small sides of a workpiece. A complete coating of all the edges can be appropriate, for example, when wood plates, as workpiece, are to be incorporated in open pieces of furniture, which are consequently visible all around. In the case of enclosed high-value pieces of furniture as well, a coating of all the edge areas may be appropriate, so that the coated wood plates can be incorporated independently of a certain orientation, which is appropriate particularly for self-installation and for moving. In many pieces of furniture, particularly shelves, two longitudinal edges are visible, and therefore a coating of at least these two longitudinal edges and the transverse edges connecting the longitudinal edges is required.

Moreover, it is advantageous that the conveyance device is operated with an adjustable transport speed of 15 m/min to 30 m/min, preferably of 22.5 m/min.

By setting the transport or advance speed, the coating result is optimized, and, in particular, the coating intensity can be controlled in this manner.

Furthermore, it can be provided that, during the coating method, a device according to claims 1-9 is used.

A device for coating according to claims 1-9 allows optimal coating results for the edge areas of the small sides.

### BRIEF DESCRIPTION OF THE DRAWINGS

Additional properties, characteristics and advantages of the invention are described below in reference to figures of a preferred embodiment of the coating device and of the coating method. The figures show, in detail:

FIG. 1—a diagrammatic perspective representation of a coating stamp with spraying device;

FIG. 2—a schematic perspective representation of a coating roller with spraying device;

FIG. 3—a diagrammatic perspective representation of a coating device;

FIG. 4—a diagrammatic perspective representation of a cut-out of the coating device of FIG. 3 from another viewing angle; and

FIG. 5—a diagrammatic structure of the coating device.

### DETAILED DESCRIPTION OF THE PREFERRED EMBODIMENTS

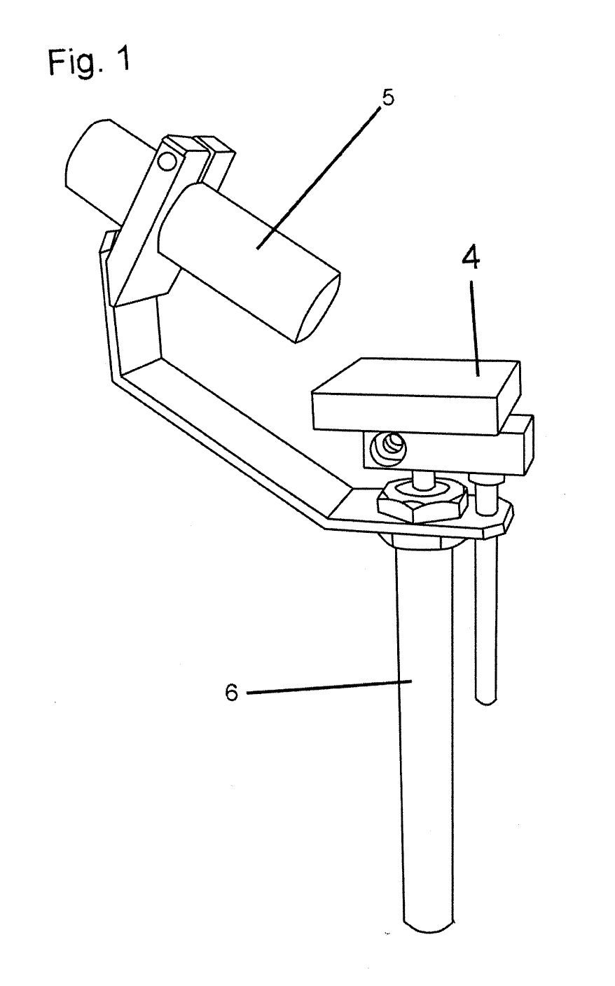

FIG. 1 shows a coating stamp 4 having a spraying device 5 arranged on the coating stamp 4. The coating stamp 4 having the spraying device 5 is deflectable by a pneumatic cylinder 6, and can therefore be advanced by an air blast to a workpiece (not represented in FIG. 1). For the coating of the front and rear—in the conveyance direction—transverse edge of the workpiece, two of the coating stamps 4 represented in FIG. 1 are generally provided in a coating device. The air blast can be triggered, for example, by a temporally defined opening and closing of a valve (not represented in FIG. 1) associated with a pneumatic cylinder 6. In contrast to the coating roller, the spraying devices 5 of the coating stamps 4 are supplied only immediately before the respective coating stamps are advanced to the front—in the transport direction—edge or transverse edge with air by valves (not represented in FIG. 1) provided especially for this purpose. This is appropriate, since the spraying of the coating stamp 4 and the coating of the respective transverse edge of the workpiece should occur sequentially and not simultaneously.

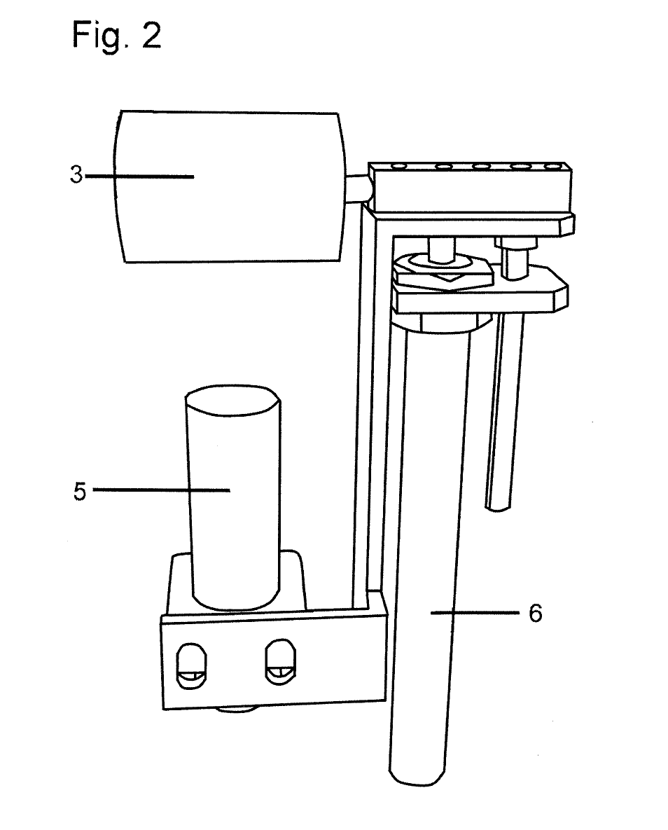

In FIG. 2, a coating roller 3 is represented, which is used for coating the longitudinal edge of a workpiece (not represented in FIG. 2), wherein the longitudinal edge of the workpiece, which is to be coated, is arranged parallel to the conveyance device. Consequently, the entire longitudinal edge of the workpiece can be coated, if, while the workpiece passes by, the coating roller 3 is pressed against the longitudinal edge, and sprayed with coating agent from the spraying device 5. For this purpose, the spray agent is sprayed onto an area of the coating roller 3, which is just not yet in contact with the longitudinal edge, but rotated immediately after the spraying by rotation of the coating roller 3 to the longitudinal edge. The spraying process and the advance of the coating roller 3 to the workpiece occur preferably pneumatically, wherein the interruption of a light barrier (not represented in FIG. 2) is evaluated as triggering event, as a result of which a valve for the air supply is opened, after an adjustable time interval. The air supply can occur, for the coating roller 3 and the spraying device 5 thereof, through a single branched air supply which is controllable by a valve. While the valve (not represented in FIG. 2) is open, a spray mist of the coating agent is applied by the supplied air from the spraying device 5 to the coating roller 3. In addition, the supplied air deflects, against the spring force, a pneumatic cylinder 6, which results in the coating roller 3 being brought close to the workpiece.

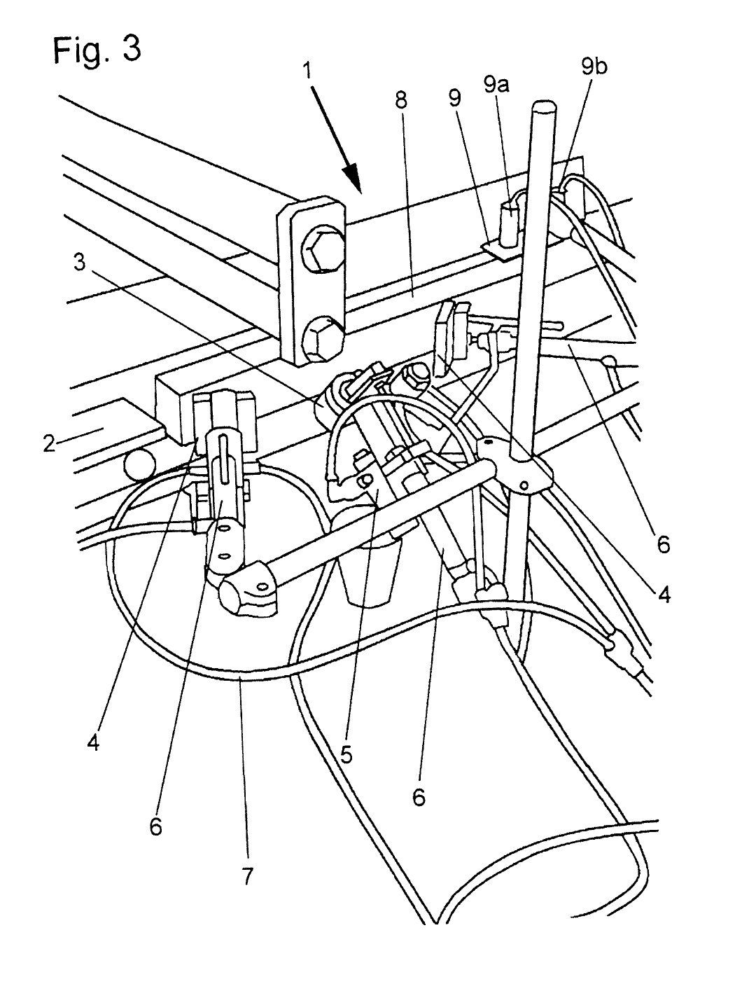

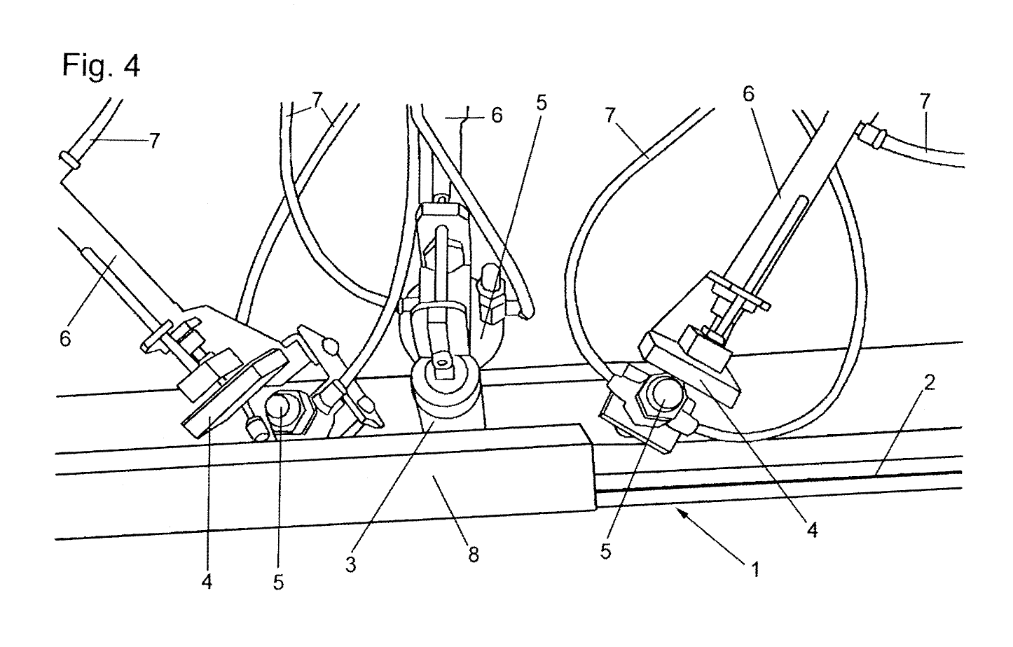

FIGS. 3 and 4 each show a partial portion of the coating device 1. In reference to FIGS. 3 and 4, one can see that the coating device 1 usually presents a coating roller 3 arranged between two coating stamps 4. The two coating stamps 4 and the coating roller 3 in each case have their own spraying device 5, which devices are represented partially covered in both figures. The coating stamps 4 and the coating roller 3 with their associated spraying devices 5 are arranged in each case on a pneumatic cylinder 6. To the spraying devices 5 and to the pneumatic cylinders 6, two air tubes 7 are connected in each case, by means of which pressurized air can be supplied or pressurized air can be removed. The workpieces 8 to be coated are passed through, on a conveyance device 2, such as, for example, on a conveyor belt, under a light barrier 9, the design of which can be double 9a, 9b. During the further course, the workpieces 8 are transported past the coating stamps 4 and past the coating roller 3, wherein coating occurs. First, the coating roller 3 is advanced to the longitudinal edge of the workpiece 8, and following that, the distal—in the conveyance direction—coating stamp 4 is sprayed by air blasts, and brought to the front—in the conveyance direction—transverse edge of the workpiece 8. After the light barrier 9 is released again, after an additional adjustable period has elapsed, a coating of the rear—in the conveyance direction—transverse edge of the workpiece 8 by the proximal coating stamp 4 occurs. After an additional adjustable period has elapsed, the coating roller 3 is retracted, by stopping the air supply by closing a valve (not represented in FIGS. 3 and 4). In this position, the coating device 1 is ready for the coating of a workpiece 8 that follows on the conveyor belt.

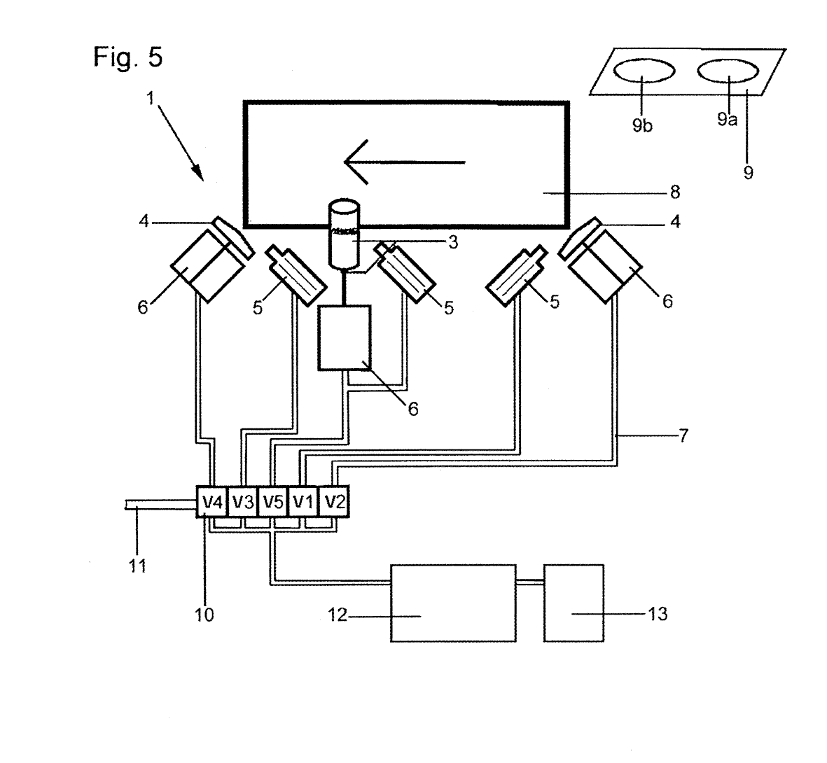

FIG. 5 shows the diagrammatic structure of the coating device 1. In this figure one can see in particular how the individual pneumatic cylinders 6 of the coating stamps 4 or of the coating roller 3, and the spraying devices 5 are controllable by different valves 10 V1 to V5. The coating roller 3 and the spraying device 5 thereof require only a single valve (V5), because, for the entire duration that the coating of roller 3 is pressed against the workpiece 8, a spraying of the coating roller 3 by means of the spraying device 5 occurs. The valves 10 V1 to V5 are designed, for example, as magnetic valves, through which the individual air tubes 7 are separated from the pressurized air feed by a pressurized air main line 11. The valves are regulated by a control electronic system 12, wherein the inputs are transferred by an operating element 13 or by appropriate control software to the control electronic system 12. As to advance speed of the workpiece 8, a range from 15 m/min to 30 m/min has been found to be suitable for the coating processes, while the conveyance device 2 is operated preferably at 22.5 m/min. The actual transport speed can also be detected additionally by a double light barrier 9, 9a, 9b. The preferably selected adjustable coating parameters can be obtained from the following table, wherein the abbreviation LB is used for the light barrier:

| | Switch on | Start | | | | Switch off | Stop |
|---|---|---|---|---|---|---|---|
| Valve | result | after | | Duration | | result | after |
| V1 | LB is released | 0.01 | s | 1 | s | | |
| V2 | LB is released | 2 | s | 1 | s | | |
| V3 | LB is | 0.5 | s | 1.4 | s | | |
| | interrupted | | | | | | |
| V4 | LB is | 2 | s | 1 | s | | |
| | interrupted | | | | | | |
| V5 | LB is | 1.5 | s | | | LB is | 4 s |
| | interrupted | | | | | released | |

Using this table, one can see that the valve V5, as the sole valve, is dependent on an interruption of the light barrier 9 for the start of a coating process, and on the release of the light barrier 9 for the termination of the coating process. In this manner, the workpiece start and workpiece end information is transmitted to the coating roller 3. Through the other valves 10 V1 to V4, the two coating stamps 4 are supplied with pressurized air by means of the associated spraying devices 5. The coating of the front—in the conveyance direction—transverse edge of a workpiece 8 is regulated here by the valves V4 and V3, while the coating of the rear—in the conveyance direction—transverse edge is controlled by the valves V1 and V2. It should be noted that the valves V3 and V4 are opened at an adjustable time interval after the interruption of the light barrier 9. The valves V1 and V2, on the other hand, are triggered by a renewed release of the light barrier 9.

Modifications and substitutions by one of ordinary skill in the art are considered to be within the scope of the present invention, which is to be limited except by the allowed claims and their legal equivalents.

1. A device (1) for the application of coating agents in the edge area of the small sides of workpieces (8), comprising a conveyance device (2), a coating roller (3), and at least two coating stamps (4), wherein the coating roller (3) and/or the coating stamps (4) are advanced to the workpiece (8) with the help of pneumatic cylinders (6), wherein the coating roller (3) and the coating stamps (4) in each case include a spraying device (5), and wherein the spraying processes of the coating roller (3) and of the coating stamps (4) are in each case pneumatically controllable.

2. The device for the application of coating agents according to claim 1, characterized in that the coating device (1) in addition presents a light barrier (9), wherein a double light barrier (9a, 9b) is preferably provided.

3. The device for the application of coating agents according to claim 2, characterized in that spraying devices (5) and the pneumatic cylinders (6) are triggerable at adjustable time intervals from the interruption of the light barrier (9) or after a renewed release of the light barrier (9).

4. The device for the application of coating agents according to claim 3, characterized in that the spraying processes occur at adjustable time intervals after the interruption or release of the light barrier (9), and they last for in each case adjustable time intervals after the interruption or release of the light barrier (9).

5. The device for the application of coating agents according to claim 3, characterized in that the pneumatic cylinders (6) are deflectable at in each case adjustable time intervals after the interruption or release of the light barrier (9), and wherein the duration of the deflection of individual pneumatic cylinders (6) is controllable by adjustable time intervals after the interruption or release of the light barrier (9).

6. The device for the application of coating agents according to claim 1, characterized in that the spraying devices (5) and/or the pneumatic cylinders (6) are triggered respectively stopped or retracted by the temporally controlled opening or closing of respective associated valves (10).

7. The device for the application of coating agents according to claim 1, characterized in that a conveyor belt is provided as conveyance device (2).

8. The device for the application of coating agents according to claim 1, characterized in that the coating device (1) comprises several coating stations, wherein the workpiece (8), after leaving a coating station, and before being advanced to a following coating station, is rotated by preferably 90°, wherein, in the case of cuboid workpieces (8), up to four different coating positions are provided.

9. The device for the application of coating agents according to claim 1, characterized in that, for the setting of the time intervals, a control software (12) and/or a control panel (13) is/are provided.

10. A method for coating the edge area of the small sides of workpieces (8) with wood treatment agents and particularly with coating agents, comprising the following steps:
A. transporting of a workpiece (8) to be coated through the use of a conveyance device (2) during all the subsequent steps;
C. additionally transporting the workpiece (8) and, in the process, pressing of a coating roller (3) against a longitudinal edge or bottom edge of the workpiece (8), with simultaneous spraying of the coating roller (3) with a coating agent by means of a spraying device (5), and, in the process, coating of the edge in the transport direction, wherein step C is maintained until step H is reached;
D. spraying of a coating stamp (4), which is located distal in the conveyance direction of the conveyance device, with coating agent from a spraying device (5);
E. additional transport of the workpiece (8), and coating of a front—in the conveyance direction—transverse edge by means of the distal coating stamp (4) which is brought close to the workpiece (8) for this purpose;
F. spraying of a proximal—in the conveyance direction of the conveyance device (2)—coating stamp (4) with a coating agent from a spraying device (5);
G. additionally transporting the workpiece and coating of a rear—in the conveyance direction—transverse edge by means of the proximal coating stamp (4) brought close to the workpiece (8) for this purpose; and
H. additionally transporting the workpiece (8) and, in the process, removal of the coating roller (3) from the workpiece (8).

11. The method according to claim 10, characterized in that, as an additional step after step A and before step C the following step is provided:
B. transporting of the workpiece (8) to be coated through a light barrier (9), and as a result interruption of the light beam, wherein a double light barrier (9a, 9b) is preferably provided.

12. The method according to claim 11, characterized in that the steps C to H, which are provided besides the transport alone of the workpiece (8), are triggered at adjustable time intervals from the interruption of a light barrier (9) or after a renewed release of the light barrier (9).

13. The method according to claim 12, characterized in that steps D and E occur at adjustable time intervals after the interruption of the light barrier (9), and last for in each case adjustable time intervals after the interruption of the light barrier (9).

14. The method according to claim 12, characterized in that steps F and G occur at adjustable time intervals after the renewed release of the light barrier (9), and last for in each case adjustable time intervals after the renewed release of the light barrier (9).

15. The method according to claim 12, characterized in that step C is triggered at an adjustable time interval after the interruption of the light barrier (9), and terminated after an additional adjustable time interval after the renewed release of the light barrier (9) in step H.

16. The method according to claim 10, characterized in that all the steps C to H are triggered and respectively terminated pneumatically or/and hydraulically by the temporally controlled opening or closing of respective associated valves (10).

17. The method according to claim 10, characterized in that a conveyor belt is used as the conveyance device (2).

18. The method according to claim 10, characterized in that the treatment of the workpiece (8) in the steps A to H after the rotation of the workpiece (8) by preferably 90° is repeated, wherein, in the case of cuboid workpieces (8), up to four different treatment positions are provided.

19. The method according to claim 10, characterized in that the conveyance device (2) is operated at an adjustable transport speed of between 15 m/min to 30 m/min, preferably at a speed of 22.5 m/min.

20. The method according to claim 10, characterized in that a device (1) according to claim 1 is used in the coating method.
